(19) United States
(12) Patent Application Publication
(10) Pub. No.: US 2026/0150995 A1
(43) Pub. Date: Jun. 4, 2026

(54) ESPRESSO MACHINE WITH COLD BREW MODE

(71) Applicant: BREVILLE PTY LTD, Alexandria (AU)

(72) Inventors: Meenanath Digambar Taralkar, Alexandria (AU); Con Psarologos, Alexandria (AU); Monika Fekete, Alexandria (AU); Xiang Ren, Alexandria (AU); Andrew Domenic Gregorace, Alexandria (AU); Contance Themi Docos, Alexandria (AU); Oren Zvi, Alexandria (AU); Benjamin Graham Johnston, Alexandria (AU); Paul Donald Drummond, Alexandria (AU); Wilson Chung, Alexandria (AU)

(21) Appl. No.: 19/347,160

(22) Filed: Oct. 1, 2025

Related U.S. Application Data
(63) Continuation-in-part of application No. PCT/AU2025/050358, filed on Apr. 11, 2025.

(30) Foreign Application Priority Data
Apr. 11, 2024 (AU) 2024901016
Jul. 15, 2024 (AU) 2024902189

(51) Int. Cl. A47J 31/36; A47J 31/38; A47J 31/42; A47J 31/44; A47J 31/46; A47J 31/52

(52) U.S. Cl. CPC A47J 31/3671; A47J 31/38; A47J 31/42; A47J 31/4489; A47J 31/461; A47J 31/52

(57) ABSTRACT

An espresso machine for producing an espresso coffee beverage from coffee grounds held by a portafilter includes a water tank, a group head, a pump, a heater, a steam wand, a valve, a grinder, a controller, and a user interface. The user interface includes a grind icon that, when actuated, results in the controller operating the grinder, a brew icon that, when actuated, results in the controller operating the pump, the heater, and/or the valve for providing hot water to the group head, and a steam icon that, when actuated, results in the controller operating the pump, the heater, and/or the valve for providing steam to the steam wand.

### RELATED APPLICATIONS

This Patent Application is a continuation-in-part of PCT Patent Application No. PCT/AU2025/050358, which claims convention priority to Australian Provisional Patent Application Nos. 2024901016 and 2024902189. The contents of these applications are incorporated herein in their entirety by reference thereto.

### FIELD

This invention relates to an espresso machine for producing a coffee beverage.

### BACKGROUND

Existing espresso machines provide a versatile device for producing milk and non-milk inclusive coffee beverages, using a small quantity of concentrated coffee beverage, typically called an espresso shot. The extraction of an espresso shot typically occurs at high temperature (often between 90° C.-100° C.) and high pressures (typically at about 9 bar).

These extractions parameters create a profile of coffee flavour that is quite variable and sensitive to the precise extraction parameters, including extraction time.

Cold brew is a technique of extracting a coffee beverage from coffee grounds at comparatively low temperatures. Both room temperature water and iced water, close to 0 ° C., may be used to extract cold brew. Cold brew is typically produced at ambient pressure, such as by slow-drip extraction or pour-over extraction. Cold brew extraction tends to create a different profile of coffee flavour compared to espresso extraction, due to the different temperatures and pressures employed.

It would be desirable to provide the option in an espresso machine of providing a beverage with a flavour profile similar to cold brew extraction.

### SUMMARY

It is an object of the present invention to at least substantially address one or more of the above desires, or at least provide a useful alternative to the above-mentioned espresso machines.

There is disclosed an espresso machine for producing an espresso coffee beverage from coffee grounds held by a portafilter, the espresso machine including:
a water tank;
a group head for receiving the portafilter;
a pump between the water tank and the group head for pumping water from the water tank toward the group head;
a heater between the pump and the group head;
a steam wand for expelling steam produced by the heater heating water received from the pump;
p a valve between the group head, the steam wand and the heater;
a grinder for producing the coffee grounds;
a controller for controlling the pump, the heater, and the valve; and
a user interface for providing a user signal to the controller, the user interface having:
   a grind icon that, when actuated, results in the controller operating the grinder for producing coffee grounds;
   a brew icon that, when actuated, results in the controller operating the pump, the heater, and/or the valve for providing hot water to the group head; and
   a steam icon that, when actuated, results in the controller operating the pump, the heater, and/or the valve for providing steam to the steam wand, wherein each of the grind icon, brew icon, and steam icon, when actuated multiple times in a short time period, results in the controller operating the grinder, the pump, the heater, and/or the valve for preparing the grind path, the group head, and the steam wand, respectively, for producing the espresso coffee.

Optionally, multiple actuation of the grind icon in a short time period results in the controller operating the grinder for a grinder purge period, and then cease operation of the grinder.

Optionally, the grinder purge period is about 4 seconds.

Optionally, the grinder includes a fan operable by the controller to remove fines from the grinder, wherein following the grinder purge period, the controller operates the fan for a second grinder purge period.

Optionally, the second grinder purge period is about 1 second.

Optionally, multiple actuation of the brew icon in a short time period results in:
the controller operating the valve to direct water from the heater towards the group head,
the controller operating the heater at a maximum power, and
the controller operating the pump at a maximum power for a group head purge period.

Optionally, the group head purge period is less than an extraction period.

Optionally, the group head purge period is about 5 seconds.

Optionally, the controller waits to operate the pump until the heater has reached a minimum group head purge temperature.

Optionally, the group head purge period starts when the pump is operated by the controller.

Optionally, multiple actuation of the steam icon in a short time period results in:
the controller operating the valve to direct steam from the heater towards the steam wand,
the controller operating the heater at a maximum power, and
the controller operating the pump for a steam wand purge period.

Optionally, the steam wand purge period is about 3 seconds.

Optionally, the controller waits to operate the pump until the heater has reached a minimum steam wand purge temperature.

Optionally, the espresso machine is operable in a recipe mode and in a manual mode, wherein each of the grind icon, brew icon, and steam icon is operable to prepare the grind path, the group head, and the steam wand for producing the espresso coffee in both the manual mode and the recipe mode.

Optionally, the espresso machine of any one of claims 1 to 15, wherein the controller anticipates actuation of the grind icon to produce coffee grounds, the actuation of the brew icon to deliver the extraction dose, and/or the actuation of the steam icon to deliver steam to the steam wand according to a recipe, wherein the controller updates the position within the recipe following actuation of the grind icon, the brew icon, and/or the steam icon, and wherein the controller does not update the position within the recipe following multiple actuation within the short time period of the grind icon, the brew icon, and/or the steam icon.

### BRIEF DESCRIPTION OF THE DRAWING

Preferred embodiments of the present invention will now be described by way of example, with reference to the accompanying drawings, wherein:

FIG. 1 shows an espresso machine according to a preferred embodiment of the invention.

FIG. 2 shows a hydraulic diagram of the espresso machine of FIG. 1.

FIG. 3 shows a system diagram of the espresso machine of FIG. 1.

FIG. 4 shows a flow chart of a beverage production method using the espresso machine of FIG. 1.

FIG. 5 shows a flow chart of a cold pre-infusion of the method of FIG. 4.

FIG. 6 shows a flow chart of a hot pre-infusion of the method of FIG. 4.

FIG. 7 shows a cold extraction of the method of FIG. 4.

FIG. 8 shows a cooling dose of the method of FIG. 4.

FIG. 9 shows a blooming method of the method of FIG. 4.

FIG. 10 shows user interface elements for actuating a grind cycle.

FIG. 11 shows user interface elements for actuating a beverage production cycle.

FIG. 12 shows user interface elements for actuating a milk frothing cycle.

FIG. 13 shows user interface elements for actuating a hot water delivery.

FIG. 14 shows a chart of a temperature signal from a temperature probe of the espresso machine of FIG. 1 having a thermoblock type heater during a beverage extraction and a subsequent cooling dose.

FIG. 15 is a detailed view of the cooling dose shown in FIG. 14.

FIG. 16 shows a chart of a temperature signal from a temperature probe of the espresso machine of FIG. 1 having a thin film type heater during a beverage extraction and a subsequent cooling dose.

FIG. 17 is a detailed view of the cooling dose shown in FIG. 16.

FIG. 18 shows user interface elements of the espresso machine of FIG. 1, prompting delivery of a cooling dose.

FIG. 19 shows a user interface flow chart for the espresso machine of FIG. 1 prompting change of a grind setting indicator due to selection from a group of cold coffee beverages.

FIG. 20 shows a user interface flow chart for the espresso machine of FIG. 1 prompting change of a grind setting indicator due to selection from a group of hot coffee beverages.

FIG. 21 shows a user interface for the espresso machine of FIG. 1 when used in a manual mode.

FIG. 22 shows an alternative user interface for the espresso machine of FIG. 1 when used in the manual mode.

### DETAILED DESCRIPTION

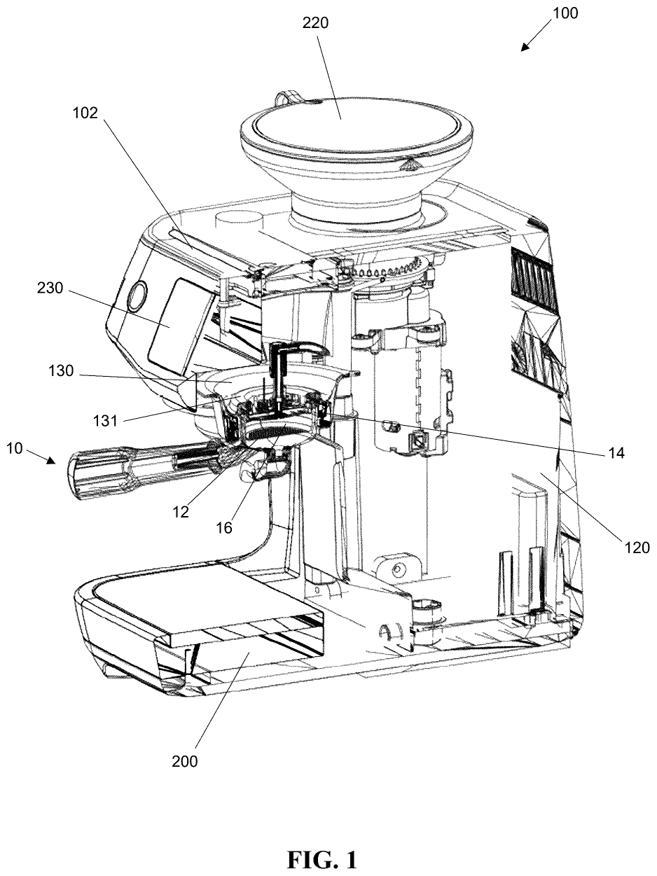

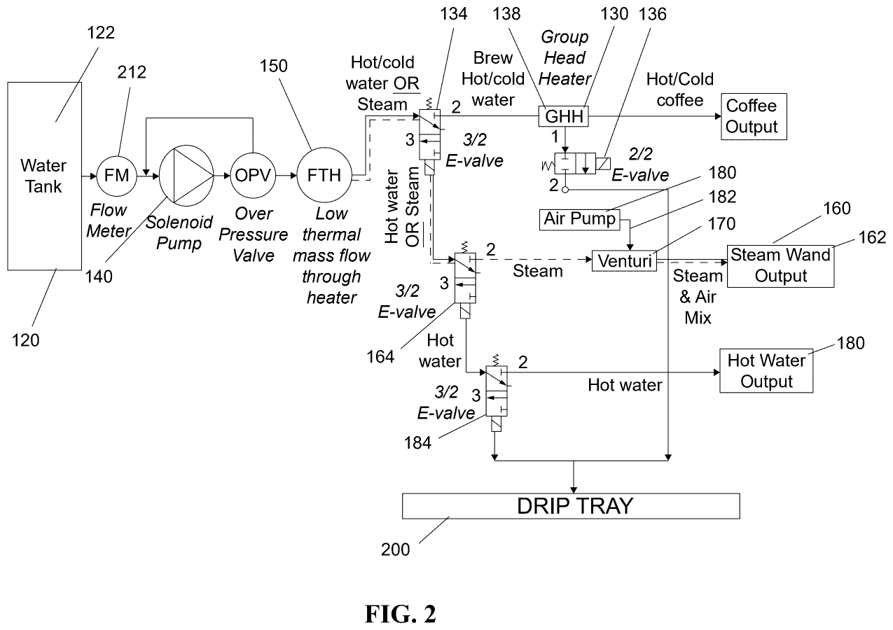

An espresso machine 100 according to a preferred embodiment of the invention, as shown in FIG. 1, may be used to produce an espresso coffee beverage (not shown) from coffee grounds 12 held by a portafilter 10. The espresso machine 100 may include a grinder 220 for providing the coffee grounds 12. The espresso machine 100 is preferably controlled by a controller 102. The machine 100 may further include a user interface 230 to provide user input for the controller 102 and/or for the controller 102 to provide information to the user. The espresso machine 100 includes a water tank 120 configured to hold a quantity of water 122. The machine 100 further includes a group head 130 for receiving the portafilter 10, for example by use of a bayonet fitting 131 in the group head 130 that is engaged by tabs 14 of the portafilter 10. As shown in FIG. 2, the machine 100 further includes a pump 140 between the water tank 120 and the group head 130, for pumping the water 122 from the water tank 120 toward the group head 130. The machine 100 further includes a heater 150 between the pump 140 and the group head 130. The heater 150 is preferably a low thermal mass heater, such as a thick film resistance heater. The heater 150 is selectively operable such that the water 122 provided to the group head 130 is either heated or non-heated. Preferably, the water 122 from the water tank 120 must pass through the heater 150 to reach the group head 130. The machine 100 may also include a drip tray 200 for capturing overflows from various locations in the machine 100, including from overflowing a receptacle into which the espresso coffee beverage is delivered. The group head 130 may include a group head valve 134, operable to selectively provide fluid communication between the heater 150 and the group head 130. The group head 130 may further include a second group head valve 136, operable to selectively provide fluid communication between the group head 130 and the drip tray 200. In this way, when the second group head valve 136 provides fluid communication between the group head 130 and the drip tray 200, water 122 provided by the heater 150 to the group head 130 flows to the drip tray 200 instead of through the portafilter 10 held by the group head 130. The group head 130 may further include a group head heater 138 located adjacent the group head 130 and/or between the group head 130 and the heater 150. The group head heater 138 is selectively operable to heat the group head 130 and/or the water 122 immediately prior to entering the group head 130. When extracting a standard espresso coffee beverage, the group head heater 138 allows better control of the temperature of the water 122 in the group head 130, due to less heat transfer from the heated water 122 to the group head 130.

As shown in FIG. 2, the espresso machine 100 may further include a steam wand 160 having a nozzle 162 for providing a steam jet suitable for frothing milk. A wand valve 164 may be positioned between the heater 150 and the steam wand 160, operable to selectively provide fluid communication between the heater 150 and the steam wand 160. Accordingly, the heater 150 and pump 140 may be operated to provide steam to the steam wand 160, for example by increasing the power applied to the heater 150 and/or decreasing the pump rate of the pump 140, such that the water flowing through the heater 150 is superheated to steam.

Preferably, when the group head valve 134 is operated to block fluid communication between the heater 150 and the group head 130, fluid communication between the heater 150 and the wand valve 164 is provided instead, for example by use of a hydraulic 3/2 valve.

Remaining with FIG. 2, the espresso machine 100 may further include a venturi nozzle 170 located between the steam wand 160 and the wand valve 164. The machine 100 may also include an air pump 180 connected to the venturi nozzle 170 such that the air pump 180 is selectively operable to provide an air flow 182 for mixing with the steam in the venturi nozzle 170, such that a proportion of the flow through the nozzle 162 is the air flow 182.

The espresso machine 100 may further include a hot water outlet 180 for providing a flow of heated water from a location other than the group head 130. The machine 100 may also include an outlet valve 184 between the heater 150 and the hot water outlet 180, operable to selectively provide fluid communication between the heater 150 and the group head 130. Preferably, when the wand valve 164 is operated to block fluid communication between the heater 150 and the steam wand 160, fluid communication between the heater 150 and the outlet valve 184 is provided instead, for example by use of a hydraulic 3/2 valve. Further, when the outlet valve 184 is operated to block fluid communication between the heater 150 and the hot water outlet 180, fluid communication between the heater 150 and the drip tray 200 is provided.

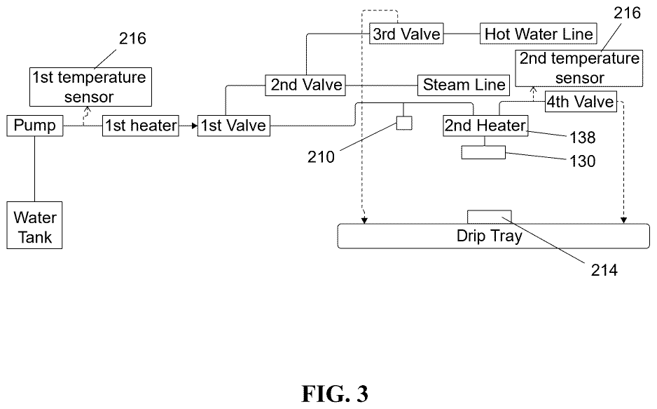

As shown in FIG. 3, the machine 100 may further include a pressure sensor 210 and one or more temperature sensors 216, and/or as shown in FIG. 2, a flow rate sensor 212, and a scale 214. The controller 102 is preferably operably connected to the pump 140, the heater 150. Further, the pressure sensor 210 may be adapted to provide a pressure signal to the controller 102 indicative of a pressure of the water 122 provided to the group head 130. Similarly, the flow rate sensor 212 may be adapted to provide a flow rate signal to the controller 102 indicative of a flow rate of the water 122 provided to the group head 130. Similarly, the temperature sensor 216 may be adapted to provide a temperature signal to the controller 102 indicative of a temperature of the water 122 provided to the group head 130. Similarly, the scale 214 may be adapted to provide a weight signal to the controller 102 indicative of a weight of the extracted espresso coffee beverage.

Use of the machine 100 will now be discussed.

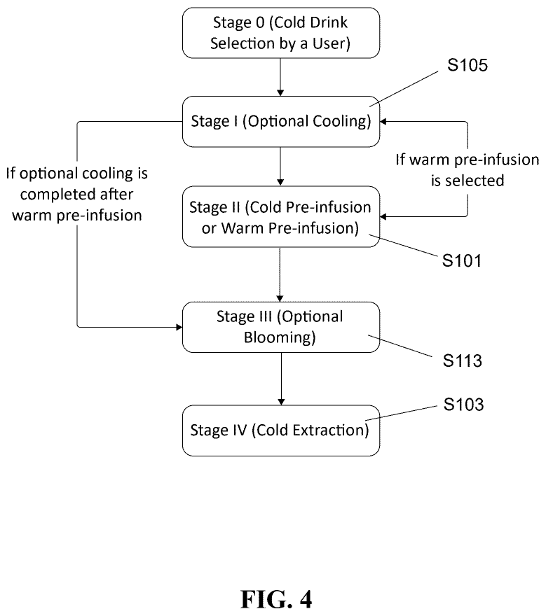

As shown in FIG. 4, use of the machine 100 for preparing an espresso coffee beverage might include, firstly, inserting the portafilter 10 holding the coffee grounds 12 into the group head 130. The, at step S101, the controller 102, using the pump 140, delivers a pre-infusion dose of water 122 from the water tank 120 to the group head 130. Subsequently, at step S103, the controller 102, using the pump 140, delivers an extraction dose of water 122 from the water tank 120 to the group head 130. As noted in FIG. 4, the pre-infusion dose and/or the extraction dose may be delivered as non-heated water 122, without operation of the heater 150. For the avoidance of doubt, the extraction dose may also be delivered using heated water 122, with operation of the heater 150, for extraction of a standard espresso coffee beverage. In one embodiment, the pre-infusion dose may be delivered as heated water 122, and the extraction dose is delivered as non-heated water 122. Preferably, during delivery of the pre-infusion dose using heated water 122, the controller 102 operates the group head heater 138, but does not operate the heater 150. The group head heater 138 may have a lower power rating than the heater 150, and the volume of water 122 used for the pre-infusion dose is typically small enough to not require use of the heater 150. Further, the water 122 of the pre-infusion dose is typically held within a cavity 16 defined by the portafilter 10 and the group head 130, allowing a longer contact time between the water 122 and the group head heater 138 compared to an extraction dose. However, as shown in the hydraulic diagrams of FIGS. 2 and 3, the non-heated water 122 flows through the heater 150 prior to being delivered to the group head 130.

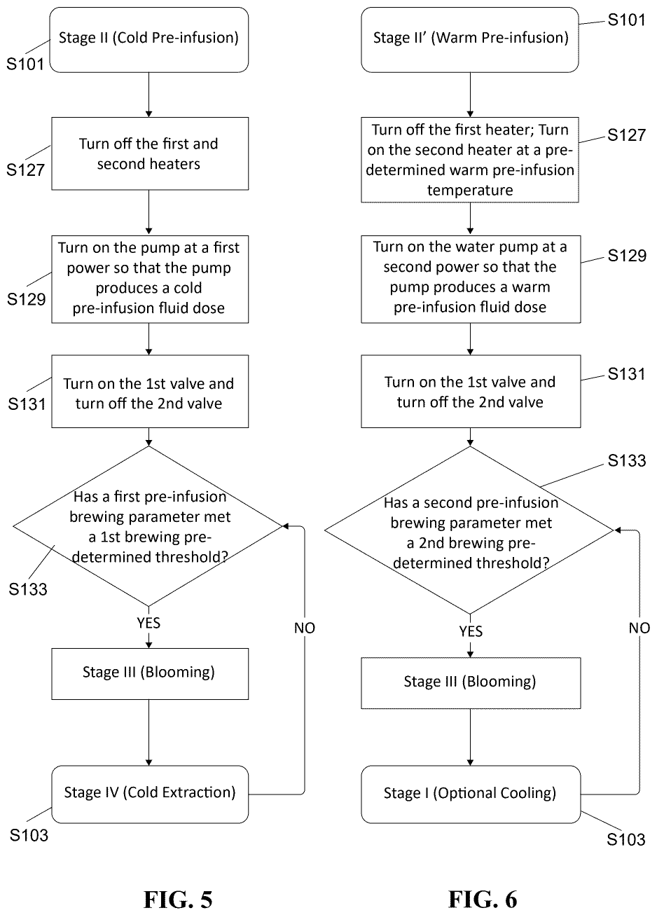

Delivery of the pre-infusion dose at step S101 is shown in more detail in FIGS. 5 and 6. FIG. 5 shows the delivery of a pre-infusion dose of non-heated water, while FIG. 6 shows the delivery of a pre-infusion dose of heated water. Turning to FIG. 5, step S127, the controller 102 ceases operation of the heater 150 and the group head heater 138. At step S129 the controller 102 operates the pump 140 at a first power. At step S131, the controller 102 operates the group head valve 134 to provide fluid communication between the heater 150, and thus the pump 140, and the group head 130, allowing the pre-infusion dose to be delivered to the group head 130. At step S133 the controller determines a pre-infusion criterion based on at least one of a pre-infusion time period, the pressure signal, the flow rate signal, and the weight signal. If the pre-infusion criterion is met, the controller 102 proceeds with the next step of the beverage extraction process, being either providing a blooming period, or delivering the extraction dose.

The delivery of a pre-infusion dose using heated water 122 shown in FIG. 6 differs from the cold pre-infusion shown in FIG. 5 in that at step S127 the controller 102 may only disable one or none of the heater 150 and the group head heater 138. Further, the controller 102 may operate the heater 150 and/or the group head heater 138 at a target pre-infusion temperature. At step S129, the controller 102 may operate the pump 140 at a second power. At step S133, the controller determines the pre-infusion criterion similarly to FIG. 5, however the controller 102 adjusts the pre-infusion criterion based on whether the heater 150 and/or the group head heater 138 is operated.

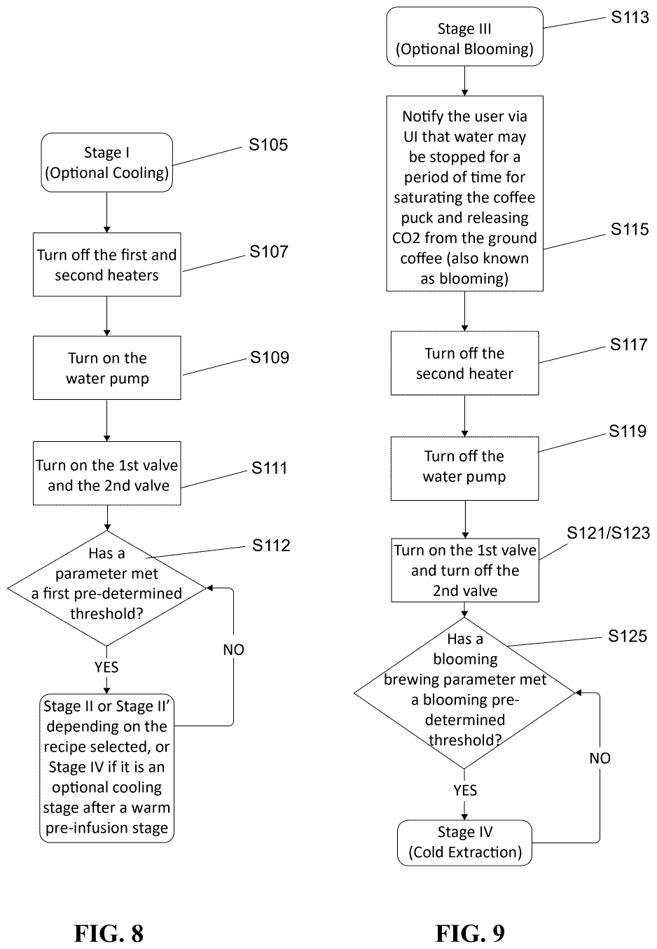

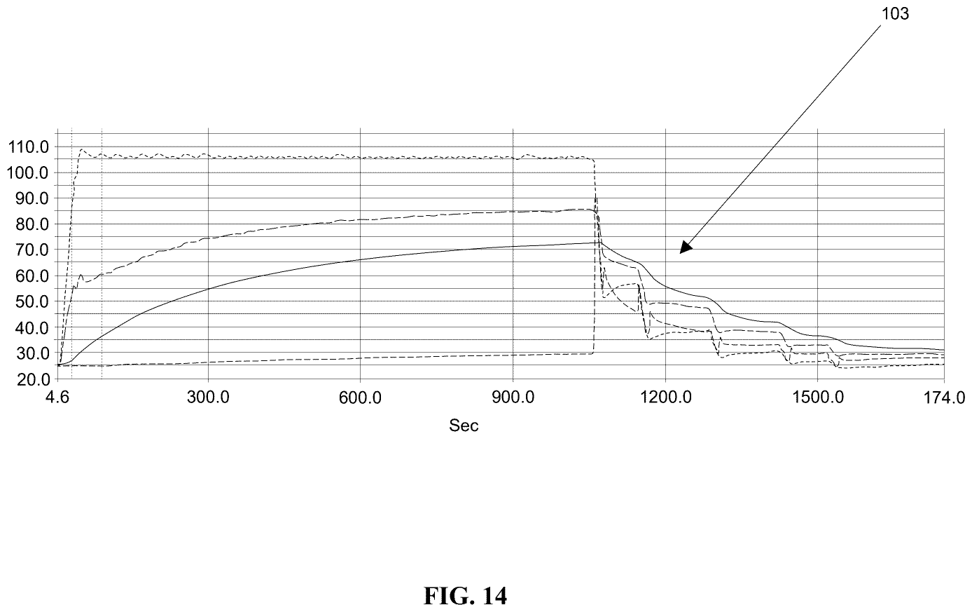

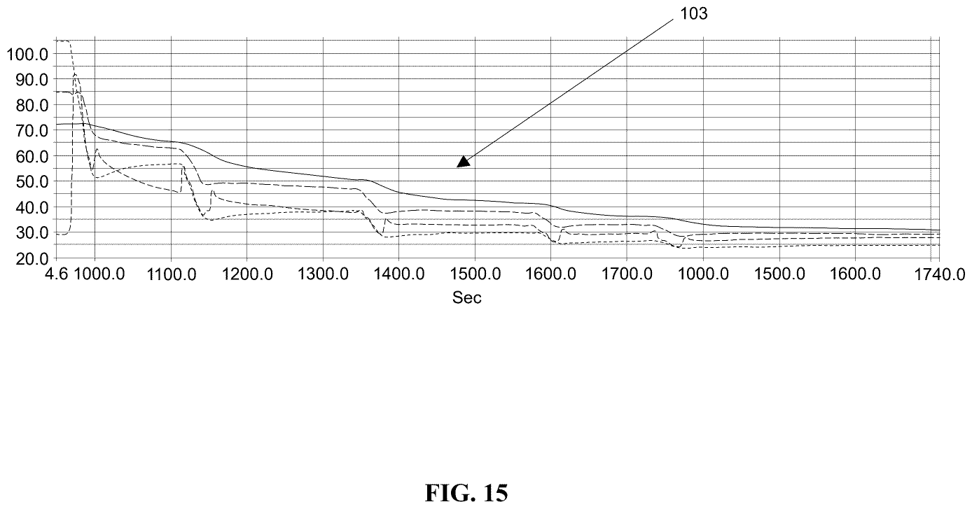

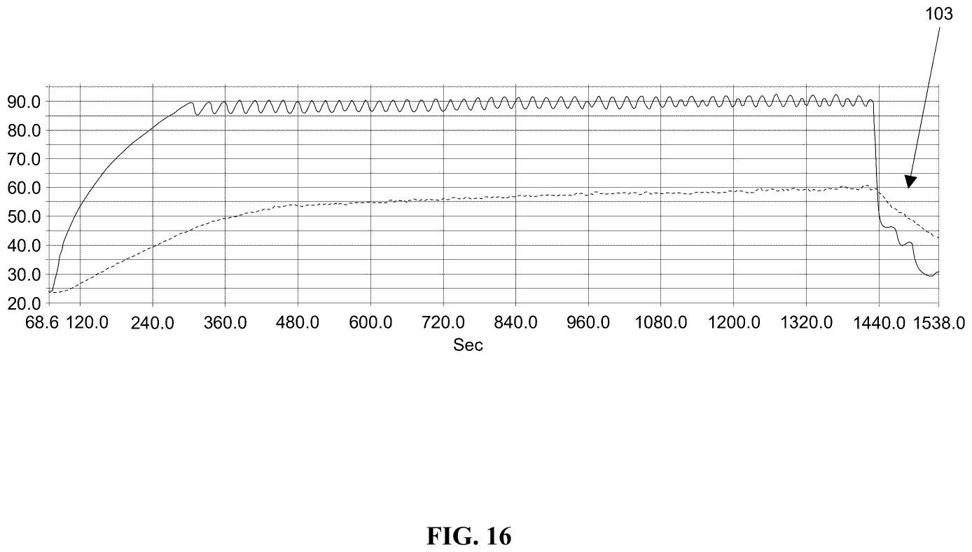

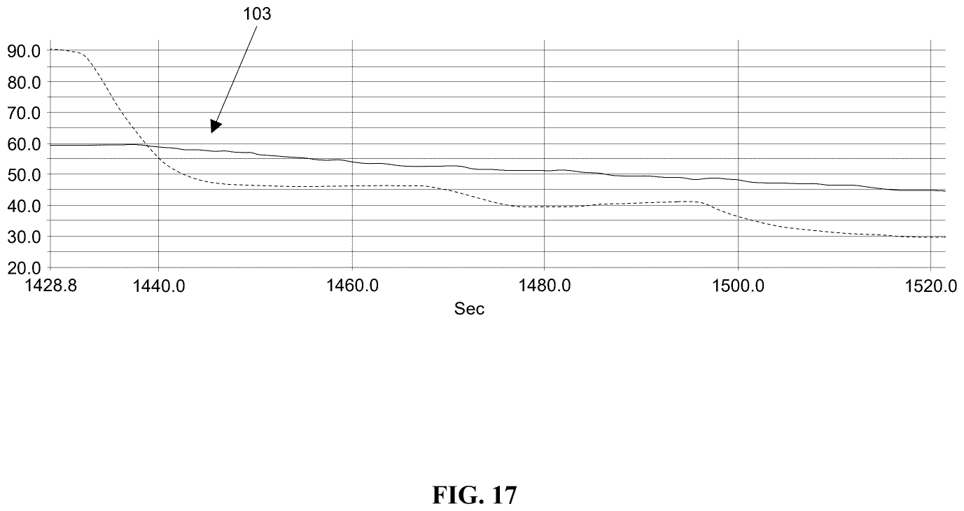

If the pre-infusion dose and/or the extraction dose are to be delivered using non-heated water 122, and the heater 150 was previously used for another beverage extraction process, or is otherwise at above room temperature, the controller 102 may as shown in FIG. 4 at step S105, using the pump 140, deliver a cooling dose of water 122 from the water tank 120 through the heater 150 to absorb heat from the heater 150. Step S105 is shown in more detail in FIG. 8. The cooling dose may be delivered to the group head 130, by operating the group head valve 134, provided that the portafilter 10 is not yet engaged with the group head 130. In preferred embodiments, the cooling dose is delivered to the drip tray 200, by operation of the group head valve 134, the wand valve 164, and the outlet valve 194, to block fluid communication between the heater 150 and the group head 130, the steam wand 160, and the fluid outlet 190, respectively. The cooling dose may also be delivered to the hot water outlet 190, by similar operation, except for operation of the outlet valve 194 to provide fluid communication between the heater 150 and the fluid outlet 190. As shown in FIG. 8, step S105 may include step S107 of turning off the heater 150 and the group head heater 138, step S109 of operating the pump 140, and step S111 of operating the group head valve 130 and the wand valve 164. Operation of the outlet valve 184 depends on whether the cooling dose is to be delivered to the drip tray 200 or the fluid outlet 180. At step S112, the controller 102 determines a cooling criterion based on one or more of the temperature signal and a cooling time period. When the controller 102 has determined that the cooling criterion has been met, the controller 102 has finished step S105 and ceases operating the pump 140. As shown in FIGS. 14 to 17, the cooling dose 103 may be provided using different amounts of water over different periods of time, depending on the structural elements of the espresso machine 100. In one embodiment, where the heater 150 includes a thermoblock type heater, as shown in FIGS. 14 and 15, the cooling dose may include delivery of about 600 ml of water of an 8 min period. In another embodiment, where the heater 150 includes a thin film type heater, as shown in FIGS. 16 and 17, the cooling dose may include delivery of about 150 ml of water over a 40 s period. A preferred cooling criterion is for the temperature sensor 216 to indicate a temperature of under 35° C. in the region of the group head 130.

In an embodiment where the pre-infusion dose is delivered using heated water 122, the cooling dose may be delivered between the pre-infusion dose and the extraction dose.

Reverting to FIG. 4, following step S103 of delivering the pre-infusion dose, the controller 102 may execute step S113 of ceasing operation of the pump 140 before delivering the extraction dose to provide a blooming period. Step S113 is described in more detail in FIG. 9. At step S115 the controller 102 may provide a notification using the user interface 230 that the pump 140 may cease operating for a period of time to provide a blooming period. At step S117 the controller 102 may cease operation of the heater 150. At step S119 the controller 102 may cease operation of the pump 140. At step S121 the controller 102 may operate the group head valve 134 to prevent backflow of water 122 from the group head 130 toward the heater 150. At step S123 the controller 102 may operate the wand valve 164 and optionally the outlet valve 184 to evacuate any excess water between the pump 140 and the group head valve 134 via the drip tray 200 or the fluid outlet 180. At step S125 the controller 102 determines a blooming criterion based on at least one of a blooming time period and the pressure signal from the pressure sensor 210. If the blooming criterion is satisfied, the controller 102, at step S103 delivers the extraction dose.

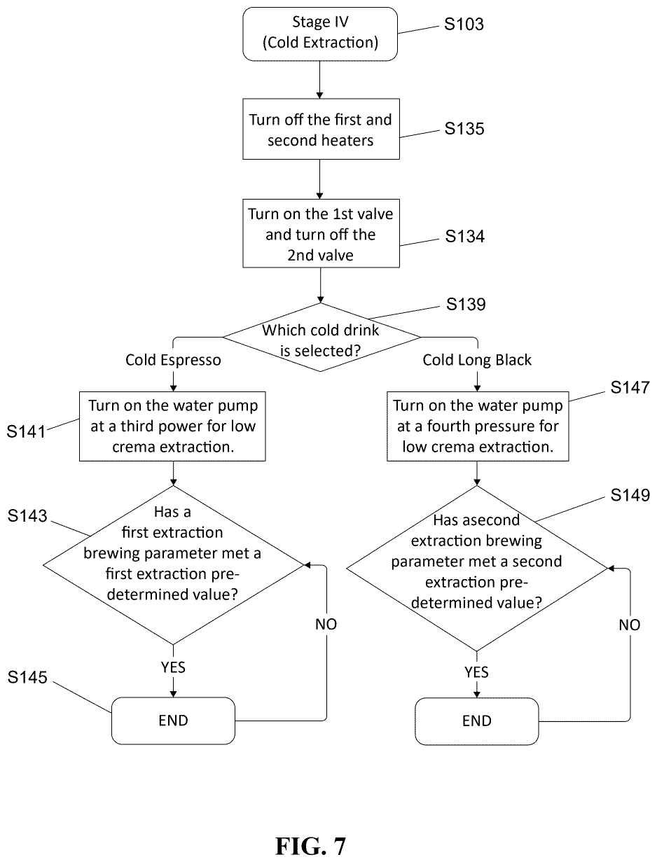

The delivery of the extraction dose at step S103 is shown in more detail at FIG. 7. At step S135, the controller 102 may cease operation of the heater 150 and the group head heater 138. At step S137, the controller 102 may operate the group head valve 134 to provide fluid communication between the pump 140 and the group head 130 through the heater 150. At step S139, the controller 102 may act on user input received via the user interface 230 to determine whether a short coffee beverage is requested, or a long coffee beverage is requested. If a short coffee beverage is requested, at step S141, the controller 102 may operate the pump 140 at a third power to deliver the extraction dose to the group head 130. At step S143, the controller 102 may determine an extraction criterion based on at least one of an extraction time period, the pressure signal, the flow rate signal, and the weight signal. If the controller 102 determines that the extraction criterion is met, at step S145, the controller 102 may end the beverage extraction process. If, alternatively, a long coffee beverage is requested, at step S147, the controller 102 may operate the pump 140 at a fourth power to deliver the extraction dose to the group head 130. The fourth power is lower than the third power, such that when the extraction dose is delivered there is a lower amount of cavitation occurring in the coffee grounds 12 during the extraction process, leading to a lower amount of crema in the extracted coffee beverage. At step S149, the controller 102 may determine an extraction criterion based on at least one of an extraction time period, the pressure signal, the flow rate signal, and the weight signal. If the controller 102 determines that the extraction criterion is met, at step S145, the controller 102 may end the beverage extraction process.

The controller 102 may, at steps S143, S149, adjust the extraction criterion based whether the heater 150 and/or the group head heater 138 is operated.

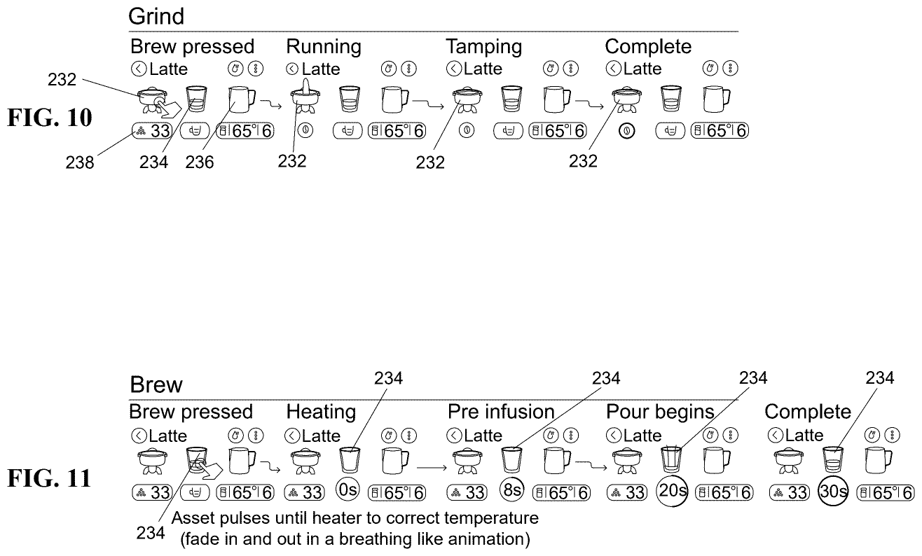

FIGS. 10 to 13 show the user interface 230 at various positions through the method shown in FIGS. 4 to 9.

As shown in FIG. 10, the controller 102 may display, when preparing a milk-based coffee beverage, using the user interface 220, a grind icon 232, an extract icon 234, and a froth icon 236. The grind icon 232 may show an image of the portafilter 10, the extract icon 234 may show a container for receiving the extracted coffee beverage, the froth icon 236 may show a container for frothing milk. The grind icon 232 may include a grind setting indicator 238 showing a number indicative of a grind size setting. On selection of the grind icon 232, the controller 102 may operate the grinder 220 for producing the coffee grounds 12. While the grinder 220 is operated, the grind setting indicator 238 may show a progress bar, or a working indicator, such as the rotating arrows shown in FIG. 10. When the operation has completed, the grind setting indicator 238 may show a finish indicator, such as the green circle shown in FIG. 10.

Turning to FIG. 11, on selection of the extract icon 234, the extract icon 234 may show an empty container and a progress bar or icon. While the controller 102 operates the heater 150 to prepare the pre-infusion dose, the container remains empty and may pulse between different opacity levels less than 100%, and the progress bar does not progress. When the controller 102 operates the pump 140 and/or heater 150 to deliver the pre-infusion dose, the progress bar begins to increment, and may show an indication of time elapsed since commencement of the pre-infusion dose. The container is still shown as empty. When the controller 102 operates the pump 140 and/or heater 150 to deliver the extraction dose, the extract icon 234 may show a small amount of beverage in the container with streams of beverage pouring into the container. At a time less than a projected extraction time period, the extract icon 234 may show a medium amount of beverage in the container with streams of beverage pouring into the container. When the extraction criterion has been met, and the controller 102 ceases delivering the extraction dose, the extract icon 234 may show a full amount of beverage in the container without streams of beverage pouring into the container. The extract icon 234 may be used to alter the extraction criterion by adjusting the extraction time period and/or adjusting a target extraction volume.

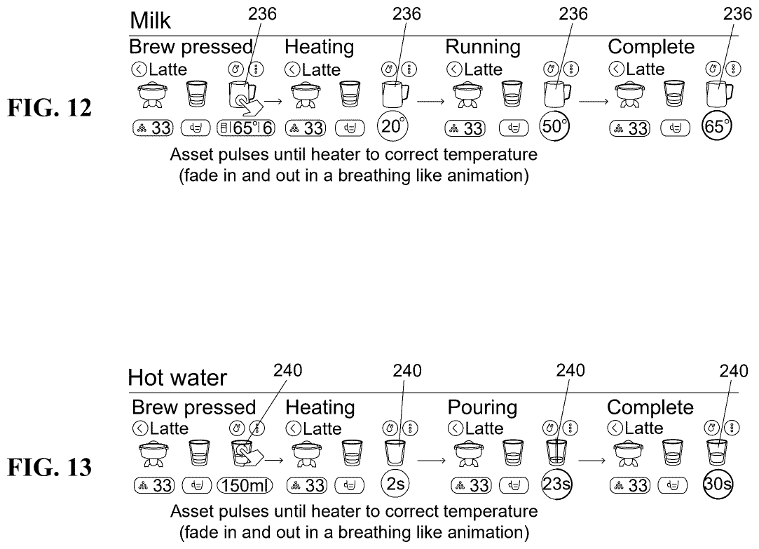

Turning to FIG. 12, on selection of the froth icon 236, the froth icon 236 may be shown at partial opacity and pulse between different opacity levels less than 100% while the controller 102 operates the heater 150 to prepare for delivering the steam flow to the steam wand 160. When the controller 102 has operated the group head valve 134 and the wand valve 164 to provide the steam flow to the steam wand 160, the froth icon 236 may show a cut-away container for frothing milk with a small volume of milk in the container. The froth icon 236 may provide an indication of a temperature of the milk being frothed by the steam wand 160. For example by providing a read-out of the milk temperature and/or a progress bar of the temperature of the milk relative to a target temperature of the milk. At a point between commencement of the frothing action and reaching of the target temperature of the milk, the froth icon 236 may show the cut-away container with a medium volume of milk in the container. When the controller 102 operates one or more of the pump 140, heater 150, group head valve 134, and the wand valve 164 to cease the frothing operation, the froth icon 236 may show the cut-away container with a large volume of milk in the container. The progress bar may show a green circle.

Turning to FIG. 13, when a selection has been received by the user interface 230 to prepare a non-milk-based coffee beverage, the froth icon 236 may be replaced by a water icon 240. On selection of the water icon 240, the water icon 240 may be shown at partial opacity and pulse between different opacity levels less than 100% while the controller 102 operates the heater 150 to prepare for delivering delivery of water 122 to the fluid outlet 180. When the controller 102 has operated the group head valve 134, the wand valve 164, and the outlet valve 184 to deliver water 122 to the fluid outlet 180, the water icon 240 may show the container for receiving the coffee beverage with a small amount of water and a stream of water flowing into the container. The water icon 240 may show a progress bar based on the amount of water 122 the controller 102 expects to deliver to the fluid outlet 180. The water icon 240 may also show an indication of time passed since the controller 102 started delivering water 122 to the fluid outlet 180. At a time between the controller 102 starting deliver of water 122 to the fluid outlet 180 and an expected completion of the delivery, the water icon 240 may show the container with a medium amount of water and a stream of water flowing into the container. When the container 102 stops delivering water 122 to the fluid outlet 180, the water icon 240 may show the container with a large volume of water and without a stream of water flowing into the container. The progress bar may be a green circle.

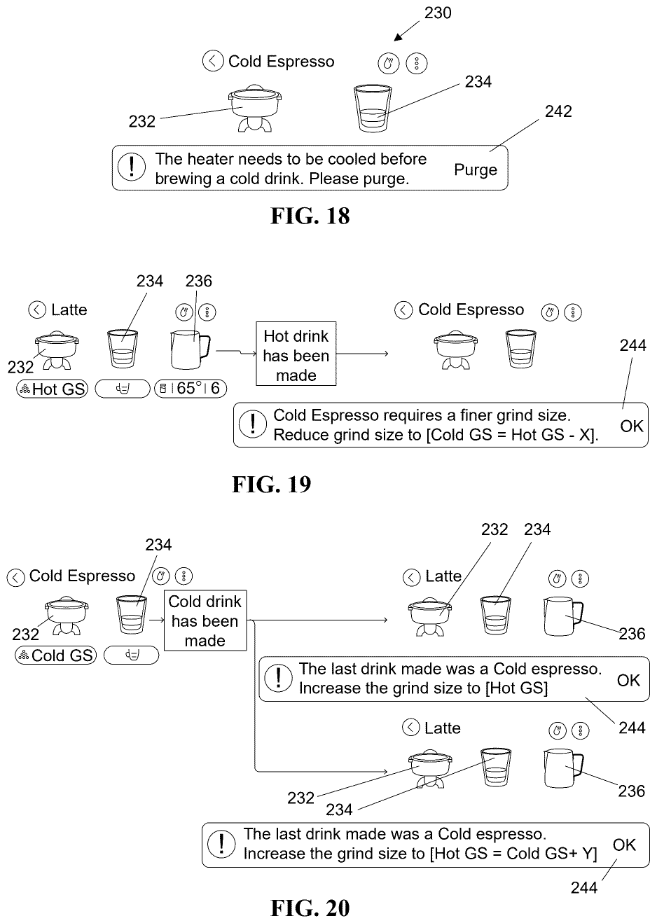

The espresso machine 100 may have a top-level user interface 230 showing different possible beverages to extract using the machine 100. The possible beverages may be considered as two groups, a group of hot coffee beverages and a group of cold coffee beverages. The beverages need not be shown in any grouping in the user interface 230. When selecting a beverage, the user interface 230 may then change to a beverage level, shown in FIGS. 18 to 20, where various parameters of the beverage may be selected before commencing the extraction. The beverage level may include the grind icon 232, the extract icon 234 and the froth icon 236.

The controller 102 may be configured to determine whether a previous beverage extraction was selected from the group of hot coffee beverages or the group of cold coffee beverages. When the controller 102 determines that the previous extraction was from the group of hot coffee beverages, and the user selects to enter the beverage level of a cold coffee beverage, the controller 102 is adapted to cause the user interface 230 to display a prompt to 242 deliver the cooling dose. In another embodiment, the controller 102 may be adapted to determine, based on the temperature signal, whether the temperature of the water is above a threshold temperature, and subsequently cause the user interface to display the prompt to deliver the cooling dose.

It is preferred that the controller 102 is adapted to, when the user interface 230 is controlled to enter the beverage level of a cold coffee beverage, cease operation of the heater 150, to commence conductive cooling of the heater 150 and associated hydraulics, potentially avoiding the need for a cooling dose, or at least reducing the amount of water required to dissipate the heat from the heater 150.

As shown in FIGS. 19 and 20, the controller 102 may determine whether the previous beverage extraction was selected from the group of cold coffee beverages or the group of hot coffee beverages with the grind setting indicator 238 correspondingly indicating a cold beverage grind setting or a hot beverage grind setting. The cold and hot beverage grind settings are terms applied to the grind setting used to extract, correspondingly, the cold or the hot coffee beverage. When the user interface 230 receives a choice from the respective opposite group of hot coffee beverages or the group of cold coffee beverages, the controller 102 may cause the user interface 230 to display a prompt 244 to change the grind setting indicator 238 to the corresponding hot or cold beverage grind setting. The controller 102 may store the hot beverage grind setting and the cold beverage grind setting in memory, such that the hot and cold beverage grind settings are retrievable from memory by the controller 102. The controller 102 may update the respective hot or cold beverage grind settings in memory following successful a beverage extraction. The controller 102 may determine the hot beverage grind setting by adding a predetermined grind setting interval, shown as “Y” in FIG. 20, to the cold beverage grind setting.

The user interface 230 may further be used to prepare the espresso machine 100, more specifically the grinder 220, the group head 130, and the steam wand 160, for operation. With use, or lack of immediately preceding use, each of the grinder 220, the group head 130, and the steam wand 160 develop problems that could result in a less desirable beverage being produced by the espresso machine 100. For example, the grinder 220 may retain coffee grounds from a previous beverage extraction. When the grinder 220 is then used, in a domestic setting perhaps one or many days later, the old coffee grounds may be thoroughly degassed and oxidized. Depending on the dosage used in a beverage extraction, the old coffee grounds may materially affect the quality of the beverage produced. Similarly, the steam wand 160, even if cleaned and purged after a beverage extraction, may retain milk solid from a previous beverage extraction at its tip. Depending on the interval between the previous beverage extraction and a new beverage extraction, these milk solids may materially affect the quality of the beverage produced by using the steam wand 160. Finally, the group head 130 of the espresso machine 100, particularly when using a thin film heater 150, is rarely at a temperature significantly above room temperature when the espresso machine 100 is otherwise ready to commence a beverage extraction. This results in a temperature drop of the extraction dose when it reaches the group head 130, and thus a temperature of the water during contact with the coffee grounds that is less than desirable. As a result, many users may perform a “blind shot”, before a beverage extraction, being the delivery of an extraction dose through the group head 130, often with the portafilter 10 attached, but without any coffee grounds in the portafilter 10. Due to a lack of specific allowance for a blind shot in previous user interfaces, users typically deliver an extraction dose, which is more energy and water than would be required to bring the group head 130 and portafilter 10 within a desirable temperature window.

The user interface 230 base configuration includes the grind icon 232 that, when actuated, results in the controller 102 operating the grinder 220 for producing coffee grounds. The user interface 230 also includes the extract or brew icon 234 that, when actuated, results in the controller 102 operating the pump 140, the heater 150, and/or one or more of the valves 134, 136 for providing hot water to the group head 130. The user interface 230 also includes a steam or froth icon 236 that, when actuated, results in the controller 102 operating the pump 140, the heater 150, and/or one or more of the valves 134, 164 for providing steam to the steam wand 160. The user interface 230 may be configured such that each of the grind icon 232, brew icon 234, and steam icon 236, when actuated multiple times in a short time period, results in the controller 102 operating the grinder 220, the pump 140, the heater 150, and/or one or more of the valves 134, 136, 164 for preparing the grinder 220, the group head 130, and the steam wand 160, respectively, for producing the coffee beverage. The short time period may be, for example, less than one second. The multiple actuation may be limited to two actuations, such that the required user interaction with the user interface 230 is a double tap on the respective icon 232, 234, 236.

Multiple actuation of the grind icon 232 in the short time period may result in the controller 102 operating the grinder 220 for a grinder purge period such that old coffee grounds are expelled from the grinder 220 and replaced with fresh coffee grounds, and then cease operation of the grinder 220. The grinder purge period may be about 4 seconds. Some grinders 220 may include a fan (not shown) operable by the controller 102 to remove fine coffee grounds from the grinder 220. In these cases, the controller 102 may, following the grinder purge period, operate the fan for a second grinder purge period, which may be about 1 second.

Multiple actuation of the brew icon 234 in the short time period may result in the controller 102 operating the valve 134 to direct water from the heater 150 towards the group head 130. If a portafilter 10 is connected, valve 136 may be closed to ensure that the water is pushed through the portafilter 10. If a portafilter 10 is not connected, valve 134 may be open to expel the water into the drip tray 200. The controller 102 operates the heater 150 at a maximum power, and operates the pump 160 at a maximum power for a group head purge period. The group head purge period may be less than the extraction dose or period, and may be about 5 seconds. The controller 102 may monitor the heater 150 before operating the pump 160, and wait to operate the pump 160 until the heater has reached a minimum group head purge temperature, the minimum group head purge temperature may be about 90° C. The group head purge period may be considered to start when the controller 102 starts operating the pump 160.

Multiple actuation of the steam icon 236 in the short time period may result in the controller 102 operating the valves 134, 136 to direct steam from the heater 150 towards the steam wand 160. The controller 102 may be operating the heater 150 at maximum power and may be operating the pump 160 at a maximum steam power for a steam wand purge period. The steam wand purge period may be about 3 seconds. The controller 102 may monitor the heater 150 before operating the pump 160, and wait to operate the pump 160 until the heater has reached a minimum steam wand purge temperature, the minimum steam wand purge temperature may be about 100° C. The steam wand purge period may be considered to start when the controller 102 starts operating the pump 160.

The use of the existing grind icon 232, extract icon 234, and steam icon 236 for the preparatory functions of respective portion of the espresso machine 100 desirably reduces the need for additional elements on the limited size of the user interface 230. Further, the preparatory functions are causally linked to the respective icon 232, 234, 236, reducing a need to educate a user about the nature, existence, and/or operation of the preparatory functions. The specific timing of the respective purge periods has been determined to desirably balance energy and water efficiency, with appropriately preparing the espresso machine 100 for the beverage extraction.

The espresso machine 100 may be operated in a default or recipe mode, as detailed in the user interfaces 230 shown in FIGS. 10 to 13 and FIGS. 18 to 20. In the recipe mode, the user interface 230 accepts input as shown above to commence operation of the grinder 220 to produce coffee grounds, to provide an extraction dose to the group head 130, and/or to provide steam to the steam wand 160. However, the detailed parameters of each of these operations is controlled by the controller 102 of the espresso machine 100 without substantive user input. For example, when preparing a beverage consisting of a shot of espresso and addition of hot water, the controller 102 may control the amount of hot water being added to the beverage. Similarly, the controller 102 will at least prompt the anticipated next step, for example the brew icon 234 will be highlighted once the grinder 220 has been operated, and/or the controller 102 may disable icons that are no longer relevant to a recipe. For example, the controller 102 might disable the grind icon 232 once the grinder 220 has already provided the ground coffee. The preparatory functions detailed above that are operated by multiple actuations of the relevant icon 232, 234, 236 within the short time period, operate independently of the state of the recipe. For example, triggering the group head purge function will not cause the recipe to consider the extraction dose to have been delivered.

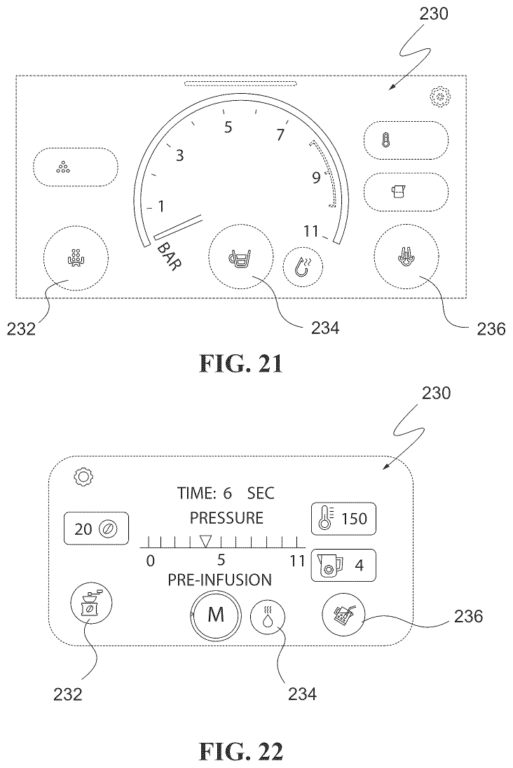

The espresso machine 100 may also be operated in a manual mode, as shown in the user interface 230 shown in FIGS. 21 and 22. In the manual mode, the user has more complete control over the parameters of the espresso machine 100 during the beverage preparation. Relevantly, the preparatory functions detailed above that are operated by multiple actuations of the relevant icon 232, 234, 236 within the short time period, also operate in the manual mode. The grind icon 232, brew icon 234, and steam icon 236 operate substantially similarly as detailed above in relation to the recipe mode.

While the preparatory functions above have been described in relation to an espresso machine 100, the person skilled in the art would understand that kitchen devices embodying only one or two of the relevant machinery could equally apply the teachings to trigger the preparatory function of the relevant machinery. For example, a stand-alone grinder 220 would only have the grind icon 232. In another example, an espresso machine without the grinder 220, would only have the brew icon 234 and the steam icon 236. An espresso machine without the grinder 220 and without the steam wand 160 would only have the brew icon 234. The teachings above are still applicable to these embodiments, causing the relevant preparatory functions when the relevant icon 232, 234, 236 is actuated multiple times within the short time period.

Advantages of the espresso machine 100 will now be discussed.

Because the heater 150 is selectively operable, it is possible to provide non-heated water 122 to the group head 130 for performing a cold brew extraction using the espresso machine 100. The provision of the steam wand 160, hot water outlet 180 and the valves 134, 164, 184 allow for operation of the espresso machine to provide classic espresso beverages, whether extracted using heated water, or non-heated water. The arrangement of the valves 134, 136, 164, 184 allows for provision of water 122 from a single pump 140 and heater 150 to a variety of end-points. Specifically, it allows the delivery of a cooling dose through the heater 150 to be delivered directly to the drip tray 200 to purge heat from the heater 150 and the hydraulic system to allow delivery of a non-heated pre-infusion or extraction dose. The use of the group head heater 138 allows the relatively fine-grained control of the temperature of the water 122 during the pre-infusion dose, when the water 122 is confined in the cavity 16. The use of the blooming period allows for an expulsion of carbon dioxide from the coffee grounds 12 and an absorption of water by the coffee grounds 12, resulting in a more predictable and complete extraction of the coffee beverage by the subsequent extraction dose.

### INTEGERS

10 portafilter
12 coffee grounds
14 tabs
16 cavity
100 espresso machine
102 controller
120 water tank
122 water
130 group head
134 group head valve
136 second group head valve
138 group head heater
140 pump
150 heater
160 steam wand
162 nozzle
164 wand valve
170 venturi nozzle
180 air pump
182 air flow
190 hot water outlet
192 flow of heated water
194 outlet valve
200 drip tray
210 pressure sensor
212 flow rate sensor
214 scale
216 temperature sensor
220 grinder
230 user interface
232 grind icon
234 extract icon
236 froth icon
238 grind setting indicator
240 water icon

1. An espresso machine for producing an espresso coffee beverage from coffee grounds held by a portafilter, the espresso machine including:
a water tank;
a group head for receiving the portafilter;
a pump between the water tank and the group head for pumping water from the water tank toward the group head;
a heater between the pump and the group head;
a steam wand for expelling steam produced by the heater heating water received from the pump;
a valve between the group head, the steam wand and the heater;
a grinder for producing the coffee grounds;
a controller for controlling the pump, the heater, and the valve; and
a user interface for providing a user signal to the controller, the user interface having:
a grind icon that, when actuated, results in the controller operating the grinder for producing coffee grounds;
a brew icon that, when actuated, results in the controller operating the pump, the heater, and/or the valve for providing hot water to the group head; and
a steam icon that, when actuated, results in the controller operating the pump, the heater, and/or the valve for providing steam to the steam wand, wherein each of the grind icon, brew icon, and steam icon, when actuated multiple times in a short time period, results in the controller operating the grinder, the pump, the heater, and/or the valve for preparing the grind path, the group head, and the steam wand, respectively, for producing the espresso coffee.

2. The espresso machine of claim 1, wherein multiple actuation of the grind icon in a short time period results in the controller operating the grinder for a grinder purge period, and then cease operation of the grinder.

3. The espresso machine of claim 2, wherein the grinder purge period is about 4 seconds.

4. The espresso machine of claim 2, wherein the grinder includes a fan operable by the controller to remove fines from the grinder, wherein following the grinder purge period, the controller operates the fan for a second grinder purge period.

5. The espresso machine of claim 4, wherein the second grinder purge period is about 1 second.

6. The espresso machine of claim 1, wherein multiple actuation of the brew icon in a short time period results in:
the controller operating the valve to direct water from the heater towards the group head,
the controller operating the heater at a maximum power, and
the controller operating the pump at a maximum power for a group head purge period.

7. The espresso machine of claim 6, wherein the group head purge period is less than an extraction period.

8. The espresso machine of claim 6, wherein the group head purge period is about 5 seconds.

9. The espresso machine of claim 6, wherein the controller waits to operate the pump until the heater has reached a minimum group head purge temperature.

10. The espresso machine of claim 9, wherein the group head purge period starts when the pump is operated by the controller.

11. The espresso machine of claim 1, wherein multiple actuation of the steam icon in a short time period results in:
the controller operating the valve to direct steam from the heater towards the steam wand,
the controller operating the heater at a maximum power, and
the controller operating the pump for a steam wand purge period.

12. The espresso machine of claim 11, wherein the steam wand purge period is about 3 seconds.

13. The espresso machine of claim 11, wherein the controller waits to operate the pump until the heater has reached a minimum steam wand purge temperature.

14. The espresso machine of claim 13, wherein the steam wand purge period starts when the pump is operated by the controller.

15. The espresso machine of claim 1, wherein the espresso machine is operable in a recipe mode and in a manual mode, wherein each of the grind icon, brew icon, and steam icon is operable to prepare the grind path, the group head, and the steam wand for producing the espresso coffee in both the manual mode and the recipe mode.

16. The espresso machine of claim 1, wherein the controller anticipates actuation of the grind icon to produce coffee grounds, the actuation of the brew icon to deliver the extraction dose, and/or the actuation of the steam icon to deliver steam to the steam wand according to a recipe, wherein the controller updates the position within the recipe following actuation of the grind icon, the brew icon, and/or the steam icon, and
wherein the controller does not update the position within the recipe following multiple actuation within the short time period of the grind icon, the brew icon, and/or the steam icon.
